(19) United States
(12) Patent Application Publication
(10) Pub. No.: US 2004/0076615 A1
(43) Pub. Date: Apr. 22, 2004

(54) Novel yeast strain for consumption

(76) Inventors: Reiner Grabowski, Gottingen (DE); Manuela Braunschweiger, Berlin (DE); Alexander Gasch, Hochheim (DE); Kornelia Berghof, Berlin (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/432,565

(22) PCT Filed: Oct. 15, 2001
(86) PCT No.: PCT/EP01/11887

(30) Foreign Application Priority Data
Nov. 24, 2000 (DE) 10058379.2

(51) Int. Cl. A01N 63/00; A01N 63/04; A01N 65/00

(52) U.S. Cl. 424/93.5

(57) ABSTRACT

The invention relates to the use of a yeast strain for human and animal consumption. It may be dispensed as a fermented drink, drink suspension, medicine or component in a baked mixture. Extracts from cells of the strain may also be consumed.

The present invention relates to a new strain of yeast with improved characteristics for human and animal consumption and a process for the characterisation of yeasts.

The yeast Saccharomyces cerevisiae was already used in ancient times for the production of fermented drinks. The most famous drinks fermented using yeast are beer and wine. Beer in the strict sense of the word is understood to be the beer that is brewed according to the Purity Law issued in 1516. According to this law, only barley, hops, water and Saccharomyces cerevisiae may be used for the production of “beer”.

Throughout the world, there are many beers which, in some cases, differ considerably in terms of their ingredients. The strains of yeast used are generally members of the genus Saccharomyces, but they differ significantly from each other in their physiological characteristics.

It is only in modern times that the use of bacteria and yeasts as probiotics has become popular. Probiotics are living micro-organisms for supplementing the diet with a beneficial effect on the host organism, e.g. improving the intestinal, microbiological balance. In recent years, an increasing number of scientific and medical research projects have been carried out which have demonstrated the essential significance of the gastrointestinal microflora for health and for the resistance of humans and animals.

Probiotics should be living microorganisms which have certain antagonistic characteristics in relation to the predominant intestinal flora, so that they can positively integrate into the natural symbiosis. Yeasts used as probiotics can frequently integrate into the biofilm of the surface of the intestine and then form a protective barrier against potential pathogens. They prevent the reproduction and settlement of bacteria ingested with food. The growth of clostridia, enterobacteria and campylobacter, which can form enterotoxins, is limited by a healthy intestinal flora.

Various strains of the genus Saccharomyces are used in different areas of medicine for therapeutic purposes, for the treatment of acne, for the prophylaxis and therapy of antibiotic-induced diarrhoea and travel diarrhoea. In general, it can be said that Saccharomyces cerevisiae, as an apathogenic bacterium, cannot reproduce or settle permanently in the human body as a host. The growth of gram positive bacteria such as lactobacilli is promoted synergistically through the vitamin content of the yeasts. The immune system is stimulated through antigen properties of the yeast cells. The activities of intestine-associated disaccharidases such as sacharase, lactase and maltase, are increased. Disaccharides are cleaved and then reabsorbed. Uncleaved, they could penetrate the deeper sections of the intestine and cause diarrhoea. Enteropathogenic E. coli, with their mannose-sensitive surface appendages, can be bound to yeast cells, so that they cannot become attached to the intestinal wall. Lining the intestinal epithelium with yeasts thus prevents pathogenic bacteria from adhering. In addition, the vitamin B content of the yeasts has a positive effect on the skin.

In particular, Saccharomyces cerevisiae can prevent the dangers of diarrhoea. The risk of diarrhoea is particularly high if the intestinal flora is reduced following the use of antibiotics. Antibiotic-resistant E. coli can reproduce and, as an indirect consequence of the repression of gram positive bacteria, penetrate the upper sections of the intestine more strongly. The precondition for their pathogenic nature is adhesion to the intestinal epithelium, which is made possible by particular microbial pathogeneity factors. Depending on the strain of E. coli, the course of an infection may vary considerably. Apart from bacterial enterocolitis and diarrhoea, it may also lead to more serious forms of illness such as haemorrhagic uraemic syndrome.

A further prophylactic application of S. cerevisiae consists of its use to combat Candida albicans mycoses. The oral ingestion of S. cerevisiae can reduce the number of intestinal candida cells.

The present invention was based on the technical problem of providing a new yeast strain which is suitable for consumption by humans and animals, whereby any adverse effect on the flavour of the medium containing the yeast must be kept to a minimum. A further technical problem was that of describing a process with which any yeast strains can be clearly separated from each other.

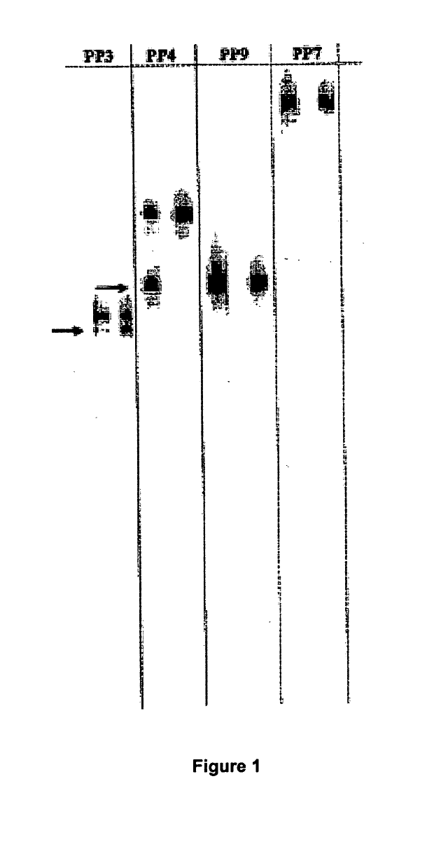

The first problem is solved according to the invention by a yeast strain which, in the molecular genetic characterisation by PCR, provides the banding pattern shown in FIG. 1 with primer pair 3, covering SEQ ID No. 5 and SEQ ID No. 6, with primer pair 4, covering SEQ ID No. 7 and SEQ ID No. 8, with primer pair 7, covering SEQ ID No. 13 and SEQ ID No. 14 and with primer pair 9, covering SEQ ID No. 17 and SEQ ID No. 18.

The second problem is solved according to the invention by a process for identifying and characterising yeasts comprising the step: carrying out a PCR analysis of the genetic material of the yeast with at least one of the primer pairs 1 to 13, preferably with at least 4 different primer pairs, and most preferably with all primer pairs 1-13.

The yeast strain according to the invention can be best characterised and identified using its genetic fingerprint, which can easily be produced by means of PCR and primer combinations according to the invention. To produce the genetic fingerprint, the primer combinations 1 to 13 are to be used with each other in whatever combinations are required. The most detailed result is naturally obtained if all 13 primer pairs are used to analyse the yeast genome. However, a particularly characteristic pattern is provided by the combination of the primer pairs 3, 4, 7 and 9. The pattern created with the various primer pairs and combinations of primer pairs represents a clear genetic fingerprint of the yeast strain in question and allows even genetically very closely related yeast strains to be distinguished. A particularly preferred strain (Saccharomyces BCE no. 14143) was stored at the Deutsche Sammlung von Mikroorganismen und Zelikulturen GmbH under storage number DSM 13850. Derivates from this are also particularly preferred. The term “derivate” is used to mean a yeast strain which differs from the strain saved through one or several nucleotide exchanges, whereby the essential characteristics are retained, especially the genetic fingerprint as obtained with a combination of primer pairs, e.g. primer pairs 3, 4, 7 and 9, particularly preferred with all primer pairs 1-13.

It is considered that primers according to the invention are primers with one of the SEQ ID nos. 1-26, sequences hybridising with these and sequences showing at least 80% identity with these sequences. Here, “hybridising” means that the hybridising sequence shows a degree of identity with the primer sequence in question which allows that, even in the presence of further sequences, only the primer sequence is recognised, whereby it lies within the scope of skilled expertise to determine the hybridisation conditions suitable for this. Preferred hybridisation conditions correspond to those of the PCR programme given in the examples with the use of a normal PCR buffer. “80% identity” means that in the reference sequence the same nucleotide is found at 8 out of 10 of the corresponding positions as in the specified sequence selected from SEQ ID nos. 1-26.

The yeast according to the invention is particularly suited for the production of preparations intended for consumption by humans and animals. The addition of yeast according to the invention leads to practically no adverse effect on the flavour of the preparation to be taken.

The yeast according to the invention is particularly suitable as a constituent of a medicament, a probiotic, a fermented drink, a suspension, an extract or a baked product.

Relevant fermented drinks include beer, non-alcoholic beer or fermented fruit juices.

In a further preferred embodiment, the yeast according to the invention is incorporated into the preparation to be dispensed in lyophilised form.

The preparation containing the yeast according to the invention is preferably used for the treatment of diarrhoea, colitis, intestinal infections, candida infections or skin diseases.

The primers according to the invention further allow a process for the identification and characterisation of yeasts, whereby the process can identify any yeasts on the basis of their genetic fingerprint, even if these yeasts can practically no longer be distinguished from each other by biotechnical parameters. For this characterisation/identification, the genome of the yeast in question is subjected to a PCR analysis, whereby at least one of the primer pairs 1 to 13 is used. The more primer pairs are used in combination for analysis of the genome in question, the more precise and detailed the genetic fingerprint will be that is obtained from the yeast in question. If, therefore, two specified yeasts are to be examined to see whether they are identical or different from each other, their genome is examined by means of the primer pairs according to the invention, whereby as many combinations of primer pairs can be used until a significant difference in the band patterns is obtained. As a rule, four different primer pairs are usually sufficient to provide a really unique genetic fingerprint. A particularly preferred combination of primer pairs in this respect is the combination of primer pairs 3, 4, 7 and 9.

With the product dispensed, the formula may contain living or dead yeast cells. In addition, the yeast cells can be separated during the production process so that only the fermented product or the product supplemented by yeast sedimentations is consumed.

A preferred Saccharomyces strain, called BCD, can be added to a juice, beer or wine drink as a probiotic suspension. The suspension may also be incubated for some time to bring about fermentation. In addition, a fermented drink may, as a secondary factor, have the alcohol produced removed from it in order to create, for example, non-alcoholic beer or wine.

In the form of a medication for animals and humans, Saccharomyces BCD can be dispensed as lyophilised yeast. In this case, it may be used to treat indications such as diarrhoea, colitis, candida infections or general stomach and intestinal disorders. In addition, it may also be used to improve the quality of the skin.

A further use of Saccharomyces BCD consists of its addition to bakery mixtures for the production of breads, biscuits, steamed yeast dumplings or similar.

Extracts of Saccharomyces BCD may be used for any of the applications mentioned above. In this case, individual components of the yeast may be administered in enriched or purified form.

The following examples and the Figure will elucidate the invention.

### DESCRIPTION OF THE FIGURE

The characterisation of Saccharomyces BCD using PCR is shown in FIG. 1. A closely related comparative strain (left) and Saccharomyces BCD (right) are shown alternating in each case. The arrows indicate the differences between the strains. Primer pairs PP3, PP4, PP9 and PP7 were used.

### EXAMPLES

Identification of the Yeast Strain

Saccharomyces BCD is a strain of the genus Saccharomyces. On the basis of a molecular biological detection process, this is clearly distinguishable from other strains of Saccharomyces, especially from strains of the species Saccharomyces cerevisiae.

The molecular biological characterisation of this strain is described below.

The yeast is cultivated for 2 days at 30° C. in a medium with 2% glucose. The genomic DNA is isolated from 2 ml overnight culture in each case, using a standard commercial kit. A PCR is then carried out as follows:

2 μl genomic DNA

1/10 vol. 10× conc. PCR buffer

2 mM MgCl₂

0.2 mM dNTP

0.4 pmol per primer (one primer pair per reaction)

Taq 1.5 U

TABLE 1
Primer pairs used

| Primer | | SEQ ID | Length |
|---|---|---|---|
| pair | Sequence | No. | (Nt) |
| PP1 | CTGGGCAGAACCGCCCATAAGAGG | 1 | 24 |
| | GACCTCCCTTTTTCGACAGAGGCG | 2 | 24 |
| PP2 | CTGCTCAACTTGTGATGGGTTTTGG | 3 | 25 |
| | CCTCGTTACTATCGTCTTCATCTTGC | 4 | 26 |
| PP3 | CGATGGAATCGAATTTGACGCCCC | 5 | 24 |
| | CCTCATCCTCACCGTCTTCAGCGGC | 6 | 25 |
| PP4 | CAGCATCCTGCTCAACAAACGCC | 7 | 23 |
| | GCAGCTGTTGTCTTGGTAGGGGC | 8 | 23 |
| PP5 | GTAAATATGCTGCGTGAATTTGCC | 9 | 24 |
| | CAAAATCGTTATGAAATTGGGTGGG | 10 | 25 |
| PP6 | CCCTTTTAAGGAAGAGCAAGCC | 11 | 22 |
| | CCACTCTCAGCTTATTGGGG | 12 | 20 |
| PP7 | GGTGACTCTAACGGCAGAGTGG | 13 | 22 |
| | GGATCTACTTGCAGTATACGGG | 14 | 22 |
| PP8 | CTA CAA TTC CAA AGG TCC TTC GC | 15 | 23 |
| | CGT GCC ATT GTC GTT TGA GGG | 16 | 21 |
| PP9 | GAA TGA TTA CTA CGC TGC TTT GGC | 17 | 24 |
| | CGG ACC ATA TCA AAC GTC CTC | 18 | 21 |
| PP10 | CGC AAG AAT CCA CCG CAA GCC | 19 | 21 |
| | GTC TTA CCG GTA TCG ACA TGA CCC | 20 | 24 |
| PP11 | CTG GAG CTA GAG TCG GAT TCA C | 21 | 22 |
| | AAG TGT TAA GGA GAA GGA GAT TG | 22 | 23 |
| PP12 | AGG TCC CGT GCT GCT CTA T | 23 | 19 |
| | GTA CCA TGC CGG ATC AAA AGT GC | 24 | 23 |
| PP13 | ACA GTC TTA TTG CCT TGA ACG AA | 25 | 23 |
| | TTA AAT AAC GAT AGG AAC CAC CAA | 16 | 24 |

This table summarises the primer pairs used in the PCR reactions.

For better identification, a primer of each pair can be linked with a dye.

PCR Programme

$\begin{matrix}5 min 95 ° C . & \\ \begin{matrix}30 s 95 ° C . \\ 1 min 50 ° C . \\ 1 min 72 ° C .\end{matrix} \} \times 35 & \\ 5 min 72 ° C . & \end{matrix}$

6 μl of the PCR product are diluted with 3 μl stop buffer and denatured for 5 minutes at 95° C. 1.5 μl of this sample are applied to a sequencing gel preheated to 50° C. After gel electrophoretic separation, the band pattern is analysed. The band patterns are characteristic of the yeast strain. In more than 50 experiments, differences between yeast strains were always proved without problems.

The band pattern is characterised by the number of bands per primer pair and the size of the bands per primer pair. Individually, there may also be no need at all for an amplification product. In combination with various primer pairs, a two-dimensional band pattern is created which allows a direct comparison between different yeast strains.

TABLE 2
Band patterns obtained with various primers with various yeasts

| Yeasts/ | | | | | | | | | | | | | | | | | | | | | | |
|---|---|---|---|---|---|---|---|---|---|---|---|---|---|---|---|---|---|---|---|---|---|---|
| Primer | 9 | 10 | 11 | 12 | 13 | 14 | 15 | 16 | 17 | 18 | 19 | 29 | 30 | 31 | 32 | 33 | 34 | 35 | 36 | 37 | 38 | 39 |
| PP3 | [symbol] | [symbol] | [symbol] | | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| PP4 | [symbol] | | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| | | | | | [symbol] | [symbol] | | [symbol] | | [symbol] | | | [symbol] | | | | [symbol] | [symbol] | [symbol] | | [symbol] | |
| PP7 | | | | | | | | | | | | | [symbol] | [symbol] | [symbol] | [symbol] | [symbol] | [symbol] | [symbol] | [symbol] | [symbol] | [symbol] |
| PP9 | [symbol] | [symbol] | | | [symbol] | [symbol] | [symbol] | [symbol] | [symbol] | [symbol] | | [symbol] | [symbol] | [symbol] | [symbol] | [symbol] | [symbol] | [symbol] | [symbol] | [symbol] | [symbol] | [symbol] |
| | [symbol] | | | | | [symbol] | | [symbol] | | [symbol] | | [symbol] | [symbol] | [symbol] | [symbol] | | [symbol] | [symbol] | [symbol] | [symbol] | [symbol] | [symbol] |
| | | | | | | | | | | | | | [symbol] | | | | | | | | | |

The table shows, for yeasts 9, 10 . . . 39, the band pattern obtained in each case with the primer pairs (PP) 3, 4, 7 and 9. No 2 of the yeasts tested produce the same band pattern for all 4 primer pairs. The results show the separation of the PCR fragments on a sequencing gel, whereby the separation was carried out under the following conditions: a DNA sequencer produced by the company LI-COR (Lincoln, USA) was used. The PCR samples (marked with the dye IRD 800) were separated by gel electrophoresis over approx. 8 hours at 1500 V, using an acrylamide gel 0.25 mm thick and 50 cm long. Simply concentrated TBE buffer was used (45 mM Tris Borate, 1 mM EDTA; production of the 10 times concentrated buffer: 108 g Tris base, 55 g boric acid and 40 ml 0.5 M EDTA pH 8.0 to 1 IH₂O.

TABLE 3
Schematic representation of the differentiation of yeasts
by means of primer pairs 1-13 from the above table

| | | Origin/ | Primer Pairs | | | | | | | | | | | | |
|---|---|---|---|---|---|---|---|---|---|---|---|---|---|---|---|
| No. | Code | Characteristic | PP1 | PP2 | PP3 | PP4 | PP5 | PP6 | PP7 | PP8 | PP9 | PP10 | PP11 | PP12 | PP13 |

Top-fermented yeasts

| | | | | | | | | | | | | | | | |
|---|---|---|---|---|---|---|---|---|---|---|---|---|---|---|---|
| 1 | K (2045) | Baker [symbol] s yeast | A | A | A | A | A | A | A | A | A | A | A | A | A |
| 2 | M (2070) | Distillery yeast | B | B | B | B | B | B | B | B | B | B | B | B | B |
| 3 | 160 | Brewer's yeast | C | C | C | C | C | C | C | C | C | C | C | C | C |
| 4 | Sa 0739 | Weizenbier yeast | D | D | D | D | D | D | D | D | D | B | D | D | D |
| 5 | Sa 07/110 | Wine yeast | F | E | E | E | E | E | E | E | E | C | D | E | E |
| 6 | Sa 07/117 | Wine yeast | E | F | F | F | E | F | F | E | F | C | D | F | F |
| 7 | Sa 07/118 | Wine yeast | E | F | F | F | E | F | F | E | F | C | D | F | F |

Bottom-fermented yeasts

| | | | | | | | | | | | | | | | |
|---|---|---|---|---|---|---|---|---|---|---|---|---|---|---|---|
| 8 | Sa 4309 | Type strain | — | Y | — | — | — | — | — | — | — | — | — | G | — |
| 9 | Sa 4311 | unknown | F | G | G | G | F | G | C | E | G | D | E | H | G |
| 10 | Sa 4313 | “Saaz” yeast | F | H | E | — | F | — | — | — | H | D | E | H | J |
| 11 | Sa 4320 | Pitch yeast | — | G | I | G | — | G | C | E | — | D | — | H | G |
| 12 | Sa 0603 | Type strain | — | H | — | H | — | — | — | — | — | D | — | H | H |
| 13 | Sa 0608 | Dust yeast | G | I | J | I | G | H | G | G | I | E | G | H | I |
| 14 | Sa 06132 | Dust yeast | F | G | I | J | F | I | C | E | J | D | E | H | ? |
| 15 | Sa 06134 | Broken yeast | F | G | I | G | F | J | C | E | K | D | E | H | G |
| 16 | Sa 06135 | Dust yeast | F | G | I | J | F | K | C | E | J | D | E | H | G |
| 17 | Sa 06139 | Japanese beer yeast | F | G | I | G | F | L | C | E | L | D | E | n.d. | G |
| 18 | Sa 06143 | Brewer's yeast | F | G | I | K | F | J | C | E | L | D | E | H | G |
| 19 | Rh | Brewer's yeast | F | G | I | G | F | M | C | E | K | D | E | H | G |

With A-M, identical band patterns are designated each time; if, therefore, “E”, for example, is shown for two different yeasts with PPI, the two yeasts with this primer pair show the same band pattern. The combination of these patterns characterises the various strains. It is interesting to note that it is also possible to distinguish between Saccharomyces cerevisiae strains whose use as brewer's yeast, wine yeast etc. is actually identical.

The PCR method described above was used to characterise Saccharomyces BCD and delimit it from closely related yeast strains. Some results are shown below by way of example; it can be seen that, of the 4 primer pairs shown, there are two primer pairs which clearly show completely different band patterns (FIG. 1, shown by arrows). FIG. 1 illustrates this result once again.

TABLE 4
Bands obtained with primer pairs 3, 4, 7, 9 with BCD and
a reference strain

| | | | Distinguished by the |
|---|---|---|---|
| | Saccharomyces | Saccharomyces | corresponding band |
| Strain designation | spec. | BCD | pattern |
| PP3 | [symbol] | [symbol] | + |
| PP4 | [symbol] | [symbol] | + |
| | [symbol] | | |
| PP9 | [symbol] | [symbol] | − |
| PP7 | [symbol] | [symbol] | − |

The strain Saccharomyces BCD (=Saccharomyces BCD no. 14143) is stored at the Deutsche Sammlung für Mikroorganismen (DSM) (German Collection of Microorganisms) in Brunswick under the number DSM 13850. In a comparison with more than 30 other strains of the species Saccharomyces using the method described above, Saccharomyces BCD shows unique molecular biological characteristics.

Cultivation of Saccharomyces BCD

The strain Saccharomyces BCD was inoculated at 2% in the DS medium for the pre-culture and incubated for 20 h at 28° C. and 120 rpm. At the point of harvest, the culture has an OD600 of approx. 25.

DS medium:

| | |
|---|---|
| Saccharose | 50.00 g/l |
| (NH₄)₂SO₄ | 5.00 g/l |
| Na glutamate | 10.00 g/l |
| (NH₄)H₂PO₄ | 3.2 g/l |
| KCl | 1.5 g/l |
| MgSO₄ | 0.75 g/l |
| CaCl₂ | 0.1 g/l |
| Myoinosite | 0.1 g/l |
| Yeast extract | 2.5 g/l |

In addition, vitamins and trace elements were added to the medium.

For a batch fermentation, 3 l batch medium were inoculated up to an initial OD600 of 0.5, corresponding to 50-60 ml of preculture. Fermentation took place in a total volume of 3 l. Fermentation is carried out at 25° C., pH 5.0, 1 vvm ventilation and a stirrer speed of 500-700 rpm for approx. 30 hours. At this point, the TS content was approx. 16 g/l; and the OD600 was 63, respectively.

Batch Medium:

| | |
|---|---|
| Saccharose | 50.00 g/l |
| (NH₄)₂SO₄ | 5.28 g/l |
| (NH₄₎H₂PO₄ | 0.70 g/l |
| KCl | 0.61 g/l |
| MgSO₄ | 0.32 g/l |
| CaCl₂ | 0.1 g/l |
| Myoinosite | 0.1 g/l |
| Yeast extract | 2.5 g/l |

Production of Fermented Drinks

The yeast was added to cherry juice. After this, the mixture was incubated for 2 days at room temperature. The flavour was tested in comparison with other yeasts. The results are summarised in the following table.

| Fermentation bacteria | | |
|---|---|---|
| added | Evaluation | Flavour* |
| Saccharomyces BCD | little gas formation, | very good |
| | slightly sour | |
| Saccharomyces cerevisiae | little gas formation, | adequate |
| Strain A | unpleasant smell | |
| Saccharomyces cerevisiae | little gas formation, | satisfactory |
| Strain B | sweet | |
| ½ Saccharomyces BCD + ½ | little gas formation, | satisfactory |
| Saccharomyces | strong fermentation | |
| cerevisiae A | | |
| ½ Saccharomyces BCD + ½ | high gas formation, | good |
| Saccharomyces | bubbling, sour | |
| cerevisiae | | |
| Strain B | | |
| ½ Saccharomyces BCD + ½ | high gas formation, | good |
| Saccharomyces | bubbling, slightly sour | |
| cerevisiae | | |
| Strain C | | |
| ⅓ Saccharomyces BCD + ⅓ | very high gas formation, | good |
| Saccharomyces | bubbling, sour | |
| cerevisiae | | |
| Strain A + ⅓ | | |
| Saccharomyces cerevisiae | | |
| Strain B | | |
| Five-part scale: very good, good, satisfactory, adequate, not adequate | | |
| *The criterion for flavour was the opinion given by 5-10 years. In the rating, an easily digestible drink, like a ‘Federweiβer’ (new, partly fermented wine) in wine drinks, was rated as “very good”. The rating “very good” was only given if the cherry juice showed flavour variants that set it clearly above the flavours of other cherry juices. An acceptable deviation from the ideal drink in terms of ease of digestibility (too sour, too much gas, | | |
| # slight flavour of cork, etc.) was classified as “good”, and a marked deviation (drink is not enjoyable to drink) was rated as “satisfactory”. Drinks that could not be swallowed and drinks causing nausea would have been rated as adequate and not adequate respectively. | | |

Saccharomyces BCD was also used for the production of kefir. It was found that the kefir product is superior in flavour to the product made with other yeasts. The following table summarises the results:

| Kefir bacteria added | Evaluation | Flavour |
|---|---|---|
| Saccharomyces BCD | little gas formation, hardly | 1.0 |
| | sour | |
| Saccharomyces cerevisiae | little gas formation, strong | 3.0 |
| Strain A | smell, little gas, little own | |
| | aroma | |
| Saccharomyces cerevisiae | little gas, sweet, little own | 4.0 |
| Strain B | aroma | |
| ½ Saccharomyces BCD + ½ | little gas, strong | 2.0 |
| Saccharomyces | fermentation, little own | |
| cerevisiae A | aroma | |
| ½ Saccharomyces BCD + ½ | very much gas, bubbling, | 4.0 |
| Saccharomyces | slightly sour, lots of own | |
| cerevisiae | aroma | |
| Strain B | | |
| ½ Saccharomyces BCD + ½ | very much gas, bubbling, | 2.5 |
| Saccharomyces | slightly sour | |
| cerevisiae | | |
| Strain C | | |
| ⅓ Saccharomyces BCD + ⅓ | very much gas, bubbling, | 2.8 |
| Saccharomyces | sour, lots of own aroma | |
| cerevisiae | | |
| Strain A + ⅓ | | |
| Saccharomyces cerevisiae | | |
| Strain C | | |

Flavour ratings from 1 (very good) to 5 (not adequate) (mean value of the ratings given by several testers). The criterion for flavour was the opinion given by 5-10 testers. In the rating, an easily digestible kefir, like a fresh yoghurt, was rated as very good. The rating of 1 (very good) was only given if the kefir showed flavour variants that set it clearly above the flavours of other kefirs. An acceptable deviation from the ideal drink in terms of ease of digestibility (too sour, too much gas, slightly bitter aftertaste, etc.) was classified as good (2), and a marked deviation (kefir is not enjoyable to drink) was rated as satisfactory (3). Drinks that could not be swallowed and drinks causing nausea were rated as adequate (4) and not adequate respectively (5). The strains A and B come from the strain collection of BioteCon Diagnostics. They represent many other tested yeast strains.

Stability of the Lyophilised Saccharomyces BCD

For dispensation as a medicine, it may by necessary to lyophilise the yeast Saccharomyces BCD. The following presents a series of experiments showing that the yeast is able to survive the process of lyophilisation in terms of quantity. In particular, it is possible to lyophilise the strain starting from yeast milk.

The following fermentation conditions lead to high living bacterial counts and allow a good survival rate in subsequent processing.

For the precultivation, the inoculation volume is 2.5%, i.e. for the cultivation of a 5 m³ fermenter, the starting gradation is as follows: 3 l→125 l→5 m³ (main culture). The preculture stages are used in each case for 20 h at 30° C. as batch starters.

For the main cultivation, a batch fermentation is carried out for 25 h at 30° C. Following this phase, concentrated saccharose solution (20-25%) is added over a further 4-5 hours. The total amount is approx. 10% of the total volume of the fermentation.

After approx. 30 h fermentation time, 100 kg yeast dry matter is produced in the 5 m³ fermenter. This corresponds to a suspension to be lyophilised with approx. 20% DM content from 500 kg wet product.

Initial Cultivation Medium:

| | |
|---|---|
| Saccharose | 50.00 g/l |
| MgSO₄ × 7H₂O | 0.25 g/l |
| (NH₄)H₂PO₄ | 0.25 g/l |
| MgSO₄ × 7H₂O | 0.55 g/l |
| NH₄Cl | 2.8 g/l |
| Meso-inosite | 0.08 g/l |
| MgCl₂ × 6 H₂O | 0.25 g/l |
| CaCl₂ × 2H₂O | 0.1 g/l |
| KH₂PO₄ | 2.0 g/l |
| Na glutamate | 10.0 g/l |
| Yeast extract | 2.5 g/l |

To separate the biomass, the culture suspension (approx. 5 m³) is firstly centrifuged and the culture supernatant thrown away. The biomass is then washed with drinking water. This washing stage is carried out with approx. 15% water in relation to the processed yeast suspension.

For freeze drying, the washed wet biomass is diluted with 20% protective medium (in relation to the dry matter). Depending on the moisture content of the separated yeast, the protective medium is added in solid form as powder in the case of a yeast milk, or as a 20% aqueous solution for the resuspension of a semi-solid yeast mass.

The freezing process is crucially important for the vitality of the yeast cells. Slow freezing with a temperature change of 1° C./min produces the optimum survival rate in the product. Lyophilisation is carried out at a temperature between −20 and −30° C. After the end of lyophilisation, the product contains at least 2×10¹⁰ yeast cells capable of surviving and has a water content of <5%. With a suspension of 1.5 g Saccharomyces BCD in 5 ml water, the eutectic point was defined to be −18° C.

The following are the survival rates of the lyophilised yeast product when various protective media are used.

| | | | | | Neosorb ®/ | Neosorb ®/ |
|---|---|---|---|---|---|---|
| Time | | Neosorb ®/ | Gluci BC | Gluci BC | Gluci BC | Gluci BC |
| (days) | Gluci TU | Gluci TU | 1A | 1B | 2A | 2B |
| 0 | 1.80 × 10¹⁰ | 2.01 × 10¹⁰ | 2.27 × 10¹⁰ | 2.59 × 10¹⁰ | 2.25 × 10¹⁰ | 2.25 × 10¹⁰ |
| 7 | 2.14 × 10¹⁰ | 2.28 × 10¹⁰ | 2.01 × 10¹⁰ | 2.13 × 10¹⁰ | 1.94 × 10¹⁰ | 2.20 × 10¹⁰ |
| 22 | 1.64 × 10¹⁰ | 1.45 × 10¹⁰ | 2.08 × 10¹⁰ | 2.31 × 10¹⁰ | 1.74 × 10¹⁰ | 1.84 × 10¹⁰ |
| 35 | 1.31 × 10¹⁰ | 1.51 × 10¹⁰ | 1.37 × 10¹⁰ | 1.60 × 10¹⁰ | 1.97 × 10¹⁰ | 2.16 × 10¹⁰ |
| 49 | 1.43 × 10¹⁰ | 1.57 × 10¹⁰ | 1.16 × 10¹⁰ | 1.39 × 10¹⁰ | 1.60 × 10¹⁰ | 1.70 × 10¹⁰ |
| 70 | 9.65 × 10¹⁰ | 1.18 × 10¹⁰ | 1.03 × 10¹⁰ | 1.05 × 10¹⁰ | 1.23 × 10¹⁰ | 1.56 × 10¹⁰ |

Health Applications

For use as a probiotic, Saccharomyces BCD can be taken as a suspension. In this case, the yeast can be suspended in a drink. It is also possible to ferment the drink for a few days using the yeast. Since alcohol is produced in this way, a probiotic beer or probiotic wine can be produced in this way. In addition, the alcohol can be removed from these alcoholic drinks as a secondary process so that probiotic alcohol-reduced or alcohol-free fermented drinks can be produced.

For dispensing as a medicine, Saccharomyces BCD can be lyophilised. In this case, a high cell number can be ingested by humans and animals. After the dispensing of Saccharomyces BCD, a marked reduction of diarrhoea in horses was observed, for example.

Other applications include the use of Saccharomyces BCD as a component in baked foods such as bread, cakes, biscuits and so on. Extracts of this yeast can also be produced. In this case, individual components may be enriched or isolated for consumption.

1. Yeast strain which in molecular genetic characterisation using PCR
with the primer pair 3 covering SEQ ID No. 5 and SEQ ID No. 6;
with the primer pair 4 covering SEQ ID No. 7 and SEQ ID No. 8;
with the primer pair 7 covering SEQ ID No. 13 and SEQ ID No. 14;
with the primer pair 9 covering SEQ ID No. 17 and SEQ ID No. 18
provides the band pattern shown in FIG. 1.

2. Yeast strain according to claim 1 which provides the band pattern according to PCR as obtained with the primer pairs 1-13.

3. Yeast strain according to claim 1 or 2 with the storage number DSM 13850 and derivates derived therefrom.

4. Primer for the molecular genetic characterisation of yeasts selected from:
one of the primers with one of the sequences according to SEQ ID No. 1 to 26,
sequences that hybridise with the named primer sequences, and
sequences which are at least 80% identical with one of the sequences according to SEQ ID No. 1 to 26.

5. Use of a yeast according to one of the claims 1 to 3 in products for ingestion by animals and/or humans.

6. Use according to claim 5, characterised in that the product is a medication, a probiotic, a fermented drink, a suspension, an extract or a bakery product.

7. Use according to one of the claims 5 or 6, characterised in that the yeast in lyophilised form is added to an extract thereof or its culture supernatant.

8. Use according to one of the claims 5 to 7, characterised in that the product is used for the treatment of diarrhoea, colitis, intestinal infections, candida infections or skin diseases.

9. Product containing a yeast strain according to one of the claims 1 to 3 or a lyophilised form thereof or culture supernatants or an extract thereof for dispensing to humans and/or animals.

10. Procedure for the identification and characterisation of yeast comprising the step: Execution of a PCR analysis of the genetic material of the yeast with at least one of the primer pairs 1-13, preferably with at least 4 different primer pairs, and most preferably with all primer pairs 1-13.


SEQUENCE LISTING (26 sequences)

SEQ ID NO: 1 - DNA, 24 bp, Artificial sequence
  Description of the artificial sequence primer for the differentiation of phylogenetic units, such as strains, substrains, species
ctgggcagaaccgcccataagagg

SEQ ID NO: 2 - DNA, 24 bp, Artificial sequence
  Description of the artificial sequence primer for the differentiation of phylogenetic units, such as strains, substrains, species
gacctccctttttcgacagaggcg

SEQ ID NO: 3 - DNA, 25 bp, Artificial sequence
  Description of the artificial sequence primer for the differentiation of phylogenetic units, such as strains, substrains, species
ctgctcaacttgtgatgggttttgg

SEQ ID NO: 4 - DNA, 26 bp, Artificial sequence
  Description of the artificial sequence primer for the differentiation of phylogenetic units, such as strains, substrains, species
cctcgttactatcgtcttcatcttgc

SEQ ID NO: 5 - DNA, 24 bp, Artificial sequence
  Description of the artificial sequence primer for the differentiation of phylogenetic units, such as strains, substrains, species
cgatggaatcgaatttgacgcccc

SEQ ID NO: 6 - DNA, 25 bp, Artificial sequence
  Description of the artificial sequence primer for the differentiation of phylogenetic units, such as strains, substrains, species
cctcatcctcaccgtcttcagcggc

SEQ ID NO: 7 - DNA, 23 bp, Artificial sequence
  Description of the artificial sequence primer for the differentiation of phylogenetic units, such as strains, substrains, species
cagcatcctgctcaacaaacgcc

SEQ ID NO: 8 - DNA, 23 bp, Artificial sequence
  Description of the artificial sequence primer for the differentiation of phylogenetic units, such as strains, substrains, species
gcagctgttgtcttggtaggggc

SEQ ID NO: 9 - DNA, 24 bp, Artificial sequence
  Description of the artificial sequence primer for the differentiation of phylogenetic units, such as strains, substrains, species
gtaaatatgctgcgtgaatttgcc

SEQ ID NO: 10 - DNA, 25 bp, Artificial sequence
  Description of the artificial sequence primer for the differentiation of phylogenetic units, such as strains, substrains, species
caaaatcgttatgaaattgggtggg

SEQ ID NO: 11 - DNA, 22 bp, Artificial sequence
  Description of the artificial sequence primer for the differentiation of phylogenetic units, such as strains, substrains, species
cccttttaaggaagagcaagcc

SEQ ID NO: 12 - DNA, 20 bp, Artificial sequence
  Description of the artificial sequence primer for the differentiation of phylogenetic units, such as strains, substrains, species
ccactctcagcttattgggg

SEQ ID NO: 13 - DNA, 22 bp, Artificial sequence
  Description of the artificial sequence primer for the differentiation of phylogenetic units, such as strains, substrains, species
ggtgactctaacggcagagtgg

SEQ ID NO: 14 - DNA, 22 bp, Artificial sequence
  Description of the artificial sequence primer for the differentiation of phylogenetic units, such as strains, substrains, species
ggatctacttgcagtatacggg

SEQ ID NO: 15 - DNA, 23 bp, Artificial sequence
  Description of the artificial sequence primer for the differentiation of phylogenetic units, such as strains, substrains, species
ctacaattccaaaggtccttcgc

SEQ ID NO: 16 - DNA, 21 bp, Artificial sequence
  Description of the artificial sequence primer for the differentiation of phylogenetic units, such as strains, substrains, species
cgtgccattgtcgtttgaggg

SEQ ID NO: 17 - DNA, 24 bp, Artificial sequence
  Description of the artificial sequence primer for the differentiation of phylogenetic units, such as strains, substrains, species
gaatgattactacgctgctttggc

SEQ ID NO: 18 - DNA, 21 bp, Artificial sequence
  Description of the artificial sequence primer for the differentiation of phylogenetic units, such as strains, substrains, species
cggaccatatcaaacgtcctc

SEQ ID NO: 19 - DNA, 21 bp, Artificial sequence
  Description of the artificial sequence primer for the differentiation of phylogenetic units, such as strains, substrains, species
cgcaagaatccaccgcaagcc

SEQ ID NO: 20 - DNA, 24 bp, Artificial sequence
  Description of the artificial sequence primer for the differentiation of phylogenetic units, such as strains, substrains, species
gtcttaccggtatcgacatgaccc

SEQ ID NO: 21 - DNA, 22 bp, Artificial sequence
  Description of the artificial sequence primer for the differentiation of phylogenetic units, such as strains, substrains, species
ctggagctagagtcggattcac

SEQ ID NO: 22 - DNA, 23 bp, Artificial sequence
  Description of the artificial sequence primer for the differentiation of phylogenetic units, such as strains, substrains, species
aagtgttaaggagaaggagattg

SEQ ID NO: 23 - DNA, 19 bp, Artificial sequence
  Description of the artificial sequence primer for the differentiation of phylogenetic units, such as strains, substrains, species
aggtcccgtgctgctctat

SEQ ID NO: 24 - DNA, 23 bp, Artificial sequence
  Description of the artificial sequence primer for the differentiation of phylogenetic units, such as strains, substrains, species
gtaccatgccggatcaaaagtgc

SEQ ID NO: 25 - DNA, 23 bp, Artificial sequence
  Description of the artificial sequence primer for the differentiation of phylogenetic units, such as strains, substrains, species
acagtcttattgccttgaacgaa

SEQ ID NO: 26 - DNA, 24 bp, Artificial sequence
  Description of the artificial sequence primer for the differentiation of phylogenetic units, such as strains, substrains, species
ttaaataacgataggaaccaccaa